(19) United States
(12) Patent Application Publication
(10) Pub. No.: US 2006/0157185 A1
(43) Pub. Date: Jul. 20, 2006

(54) Ultrasonic object consolidation using offset welding or independent tack-and-weld

(76) Inventor: Dawn White, Ann Arbor, MI (US)

Correspondence Address: John G. Posa;Gifford, Krass, Groh, Sprinkle, Anderson & Citkowski, P.C., PO Box 7021, Troy, MI, 48007-7021, US

(21) Appl. No.: 11/263,028

(22) Filed: Oct. 31, 2005

Related U.S. Application Data
(60) Provisional application No. 60/623,486, filed on Oct. 29, 2004.

(51) Int. Cl. B32B 37/00; B29C 65/00

(52) U.S. Cl. 156/73.1; 156/73.4

(57) ABSTRACT

In ultrasonic object consolidation, the location of the sonotrode may be independent, and selected (like other processing parameters such as amplitude, frequency, force, and speed), for optimum processing. According to one preferred embodiment, the improvement includes welding certain regions of the object multiple times. Alternatively or in conjunction with other steps, the method includes the act of selecting sonotrode position to minimize bulk motion of the object. The invention improves upon the existing art by optimizing the positioning of the sonotrode relative to the geometry. This may, for example, comprise independently positioning the horn to treat one or more features within a cross section of the object differently, or determining tape placement location and tacking the feedstock in advance of welding. The feedstock may be provided in any suitable form, including wires, tapes and dots.

### REFERENCE TO RELATED APPLICATION

This application claims priority to U.S. Provisional Patent Application Ser. No. 60/623,486, filed Oct. 29, 2004, the entire content of which is incorporated herein by reference.

### FIELD OF THE INVENTION

This invention relates generally to additive manufacturing technology used to produce objects of any geometry and, in particular, to improvements in ultrasonic consolidation.

### BACKGROUND OF THE INVENTION

Ultrasonic consolidation is an additive manufacturing technology used to produce objects of any geometry from uniform, featureless feedstocks, such as tapes, sheets, wires, or droplets. There are a range of methods for accomplishing the metallurgical consolidation of the feedstocks via ultrasonic energy. These include, but are not limited to, spot consolidation, continuous rotary consolidation, plate-type consolidation, and so forth.

My U.S. Pat. No. 6,519,500 is directed to a system and a method of fabricating an object by adding material layers incrementally and consolidating the layers through the use of ultrasonic vibrations and pressure. The layers are placed in position to shape the object by a material feeding unit. The raw material may be provided in various forms, including flat sheets, segments of tape, strands of filament or single dots cut from a wire roll. The material may be metallic or plastic, and its composition may vary discontinuously or gradually from one layer to the next, creating a region of functionally gradient material. Plastic or metal matrix composite material feedstocks incorporating reinforcement materials of various compositions and geometries may also be used.

If excess material is applied due to the feedstock geometry employed, such material may be removed after each layer is bonded, or at the end of the process; that is after sufficient material has been consolidated to realize the final object. A variety of tools may be used for material removal, depending on composition and the target application, including knives, drilling or milling machines, laser cutting beams, or ultrasonic cutting tools.

The consolidation is effected by ultrasonic welding equipment, which includes an ultrasonic generator, a transducer, a booster and a head unit, also called a horn or sonotrode. Ultrasonic vibrations are transmitted through the sonotrode to the common contact surface between two or more adjacent layers, which may include layers next to each other on the same plane, and/or layers stacked on top of each other. The orientation of the sonotrode is preferably adjusted so that the direction of the ultrasonic vibrations is normal to the contact surface when consolidating layers of plastic material, and parallel to the contact surface when consolidating layers of metal.

The layers are fed sequentially and additively according to a layer-by-layer computer model description of the object, which is generated by a computer-aided design (CAD) system. The CAD system, which holds the layered description of the object, interfaces with a numerical controller, which in turn controls one or more actuators. The actuators impart motion in multiple directions, preferably three orthogonal directions, so that each layer of material is accurately placed in position and clamped under pressure. The actuators also guide the motion of the sonotrode, so that ultrasonic vibrations are transmitted in the direction required through the common contact surfaces of the layers undergoing consolidation.

In the ultrasonic consolidation process, among the steps that must be completed are placement of the feedstock, and consolidation of the feedstock. One embodiment described in my '500 patent resides in fabricating an object by tape lay-up. Tape from a spool is fed and cut into segments to create successive sections of the object, the direction of the tape segments preferably alternating between two orthogonal directions from section to section. The sonotrode is preferably positioned to consolidate the horizontal surfaces between the sections and the vertical surfaces between adjacent segments of tape on the same section. The feedstock, in a tape or sheet form, is place and consolidated in a single step.

### SUMMARY OF THE INVENTION

In existing approaches to ultrasonic object consolidation, the assumption has been that the sonotrode would progress across, around or through a part, with the edges of the bonded regions meeting, but not overlapping. Conventional techniques also presume that sonotrode location sequence should be dependent on the initial positioning.

According to this invention, however, the location of the sonotrode may be independent, and selected (like other processing parameters such as amplitude, frequency, force, and speed), for optimum processing. According to one preferred embodiment, the improvement includes welding certain regions of the object multiple times. Alternatively or in conjunction with other steps, the method includes the act of selecting sonotrode position to minimize bulk motion of the object.

In an ultrasonic consolidation process wherein a sonotrode is used to bond a feedstock to form an object having a geometry, this invention improves upon the existing art by optimizing the positioning of the sonotrode relative to the geometry. This may, for example, comprise independently positioning the horn to treat one or more features within a cross section of the object differently, or determining tape placement location and tacking the feedstock in advance of welding. The feedstock may be provided in any suitable form, including wires, tapes and dots.

### BRIEF DESCRIPTION OF THE DRAWINGS

FIG. 1 shows how a tape or sheet can be placed and partially consolidated or “tacked down” in separate steps or in a single step.

### DETAILED DESCRIPTION OF THE INVENTION

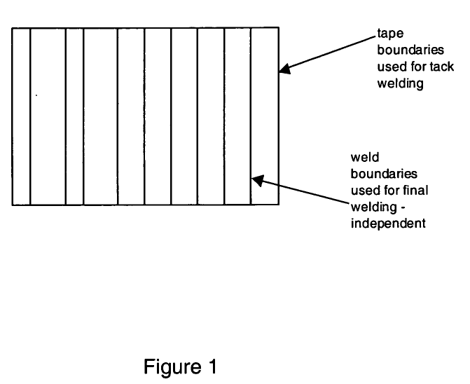

Now making reference to the drawings, FIG. 1, a tape or sheet can be placed and partially consolidated or “tacked down” in separate steps or in a single step. Once this in completed, a consolidation operation is performed to achieve a full metallurgical bond. The second welding process which fully consolidates the part can either be performed by retracing the path of the original weld, or by independently placing the follow-on welding pass in accordance with part geometry, weld parameters, or other considerations.

This independent tack-and-weld concept offers many advantages. In particular, since placement of the sonotrode with respect to various features of the part being produced will impact the quality of the resulting consolidation, the various processing conditions involved may be optimized to maximize the mechanical properties and/or fitness of the object(s) resulting from the build. For example, a specific optimum sonotrode positioning may be defined as a function of object geometry. As such, sonotrode position may be selected to weld certain regions multiple times, or to minimize bulk motion of the part being produced. Various features within a cross section may also be treated differently, using independent horn positioning to take advantage of these. Welding of feedstock edges, including tape intersections, may be performed separately and independently. Tape placement location and/or tape tacking may be determined separately from tape welding.

Other examples include part or discrete feature edges in X and Y, intersections between feedstock volumes such as tape, wire or dot edges. FIG. 1 provides examples of these. This is in contrast to conventional ultrasonic metal welding applications such as those described in the prior art, wherein identical components are bonded repetitively. As a result, a single set of processing parameters, with or without adaptive controls, is all that is available.

I claim:

1. In an ultrasonic consolidation process wherein a sonotrode is used to bond a feedstock to form an object having a geometry, the improvement comprising the step of:
optimizing the positioning of the sonotrode relative to the geometry.

2. The improvement of claim 1, including the step of:
independently positioning the horn to treat one or more features within a cross section of the object differently.

3. The improvement of claim 1, wherein the feedstock is a tape.

4. The improvement of claim 1, including the steps of:
determining tape placement location; and
tacking the tape in advance of welding the tape.

5. In an ultrasonic consolidation process wherein a sonotrode is used to bond a feedstock to form an object having a geometry, the improvement comprising the step of:
edge or tack welding the feedstock; then
fully consolidating the feedstock.

6. The improvement of claim 5, wherein the feedstock is a tape.

7. In an ultrasonic consolidation process wherein a sonotrode is used to bond a feedstock to form an object having a geometry, the improvement comprising:
independently selecting sonotrode position so as to optimize object consolidation.

8. The improvement of claim 7, including the step of:
welding certain regions of the object multiple times.

9. The improvement of claim 7, including the step of:
selecting sonotrode position to minimize bulk motion of the object.
